(19) United States
(12) Patent Application Publication
(10) Pub. No.: US 2025/0074374 A1
(43) Pub. Date: Mar. 6, 2025

(54) BRAKE SYSTEMS WITH MOTOR-DRIVEN MASTER CYLINDERS AND LOW PRESSURE ACCUMULATORS

(71) Applicant: ZF Active Safety US Inc., Livonia, MI (US)

(72) Inventor: Blaise J. Ganzel, Ann Arbor, MI (US)

(21) Appl. No.: 18/474,678

(22) Filed: Sep. 26, 2023

Related U.S. Application Data
(60) Provisional application No. 63/580,048, filed on Sep. 1, 2023.

(51) Int. Cl. B60T 8/94; B60T 8/175; B60T 8/176; B60T 13/14; B60T 13/58; B60T 13/68; B60T 13/74; B60T 15/02; B60T 17/22

(52) U.S. Cl. CPC B60T 8/94; B60T 8/175; B60T 8/176; B60T 13/142; B60T 13/58; B60T 13/686; B60T 13/745; B60T 15/028; B60T 17/22; B60T 2270/10; B60T 2270/203; B60T 2270/402; B60T 2270/404; B60T 2270/82; B60T 2270/88

(57) ABSTRACT

A brake system includes a motor-driven master cylinder for generating brake actuating pressure at first and second MC outputs for hydraulically actuating pairs of wheel brakes. A secondary brake module is configured for selectively providing pressurized hydraulic fluid at first and second PTU outputs for actuating the first and second pairs of wheel brakes. A low pressure accumulator is interposed hydraulically between the first and second pairs of wheel brakes. The low pressure accumulator is in indirect fluid communication with the reservoir via the first and second MC outputs and the master cylinder. The low pressure accumulator at least partially provides slip control to the wheel brakes in coordination with the secondary brake module when the brake system is in the normal non-failure braking mode.

### RELATED APPLICATION

This application claims priority from U.S. Provisional Patent Application No. 63/580,048 (attorney docket no. 301647-US-PSP), filed 1 Sep. 2023 and titled “Brake Systems with Motor-Driven Master Cylinders and Pump Inlet Attenuators”, the entire contents of which are incorporated herein by reference for all purposes.

This application is related to the technologies disclosed in one or more of U.S. Provisional Patent Application No. 63/580,042 (attorney docket no. 301699-US-PSP), filed 1 Sep. 2023 and titled “Brake Systems with Motor-Driven Master Cylinders and Low Pressure Accumulators”; U.S. patent application Ser. No. 18/474,657 (attorney docket no. 301158-US-NP), filed concurrently herewith and titled “Brake Systems with Motor-Driven Master Cylinders and Bypass Valves”; and U.S. Patent Application No. [PENDING] (attorney docket no. 301647-US-NP), filed concurrently herewith and titled “Brake Systems with Motor-Driven Master Cylinders and Pump Inlet Attenuators”; the entire contents of all of which are incorporated herein by reference for all purposes.

### TECHNICAL FIELD

This disclosure relates to an apparatus and method for use of brake systems with motor-driven master cylinders and pump inlet attenuators, and, more particularly, to methods and apparatus of brake systems with motor-driven master cylinders, pump inlet attenuators, and bypass valves.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published 1 Oct. 2020 by Blaise Ganzel and titled “Brake System with Multiple Pressure Sources”, and in U.S. Patent Application Publication No. 2023/0048447, published 16 Feb. 2023 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, a brake system for actuating a plurality of wheel brakes comprising first and second pairs of wheel brakes is described. The system includes a reservoir and a motor-driven master cylinder operable during a normal non-failure braking mode by actuation of an electric motor of the master cylinder to generate brake actuating pressure at first and second MC outputs for hydraulically actuating the first and second pairs of wheel brakes, respectively. A secondary brake module is configured for selectively providing pressurized hydraulic fluid at first and second PTU outputs for actuating the first and second pairs of wheel brakes in at least one of a normal non-failure braking mode and a backup braking mode. The secondary brake module includes an electric PTU motor configured to selectively pressurize the hydraulic fluid by transmitting rotary motion to at least two pump pistons. Each pump piston provides pressurized hydraulic fluid to a corresponding one of the first and second PTU outputs. Each of the first and second PTU outputs provides fluid to a corresponding one of the first and second pairs of wheel brakes. A low pressure accumulator is interposed hydraulically between the first and second pairs of wheel brakes. The low pressure accumulator is in indirect fluid communication with the reservoir via the first and second MC outputs and the master cylinder. An electronic control unit is provided for controlling at least one of the secondary brake module and the master cylinder responsive to at least one brake pressure signal. The low pressure accumulator at least partially provides slip control to the first and second pairs of wheel brakes in coordination with the secondary brake module when the brake system is in the normal non-failure braking mode.

### BRIEF DESCRIPTION OF THE DRAWINGS

For a better understanding, reference may be made to the accompanying drawings, in which:

FIG. 1 is a schematic hydraulic diagram of an example brake system according to an aspect of the present invention;

FIG. 2 is a schematic hydraulic diagram of an example brake system according to another aspect of the present invention;

FIG. 3A is a schematic cross-sectional view of a component of the brake system of any aspect of the present invention, in a first configuration;

FIG. 3B is a schematic cross-sectional view of the component of FIG. 3A, in a second configuration;

FIG. 4 is a schematic cross-sectional view of a component of the brake system of any aspect of the present invention, in a first example arrangement;

FIG. 5 is a schematic cross-sectional view of a component of the brake system of any aspect of the present invention, in a second example arrangement;

FIG. 6 is a schematic hydraulic diagram of an example brake system according to another aspect of the present invention; and

FIG. 7 is a schematic side view of an example arrangement of components for any of the brake systems of FIGS. 1-2 and 6.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

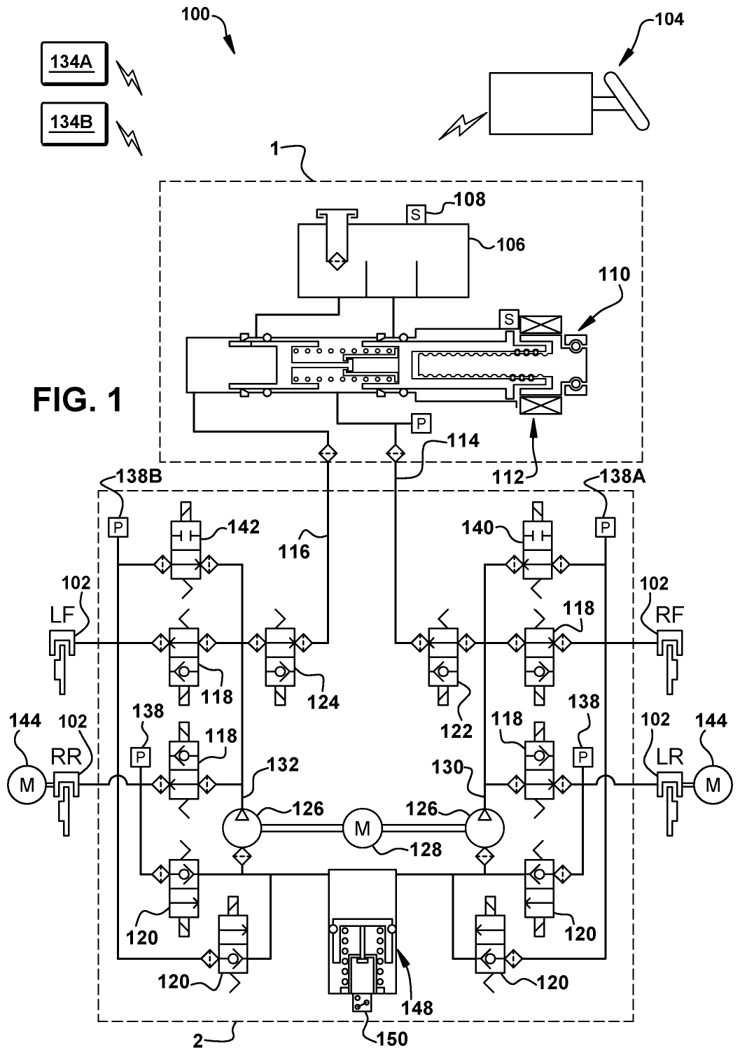

FIG. 1 schematically depicts an example brake system 100 for actuating a plurality of wheel brakes 102. The brake system 100 is shown here as a hydraulic braking system, in which fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 100 of FIG. 1, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 installed. For example, the brake systems 100 may each be configured as a vertically split or diagonally split system. No differentiation is made herein among the construction of the various wheel brakes 102, for the purposes of this description, though one of ordinary skill in the art could readily provide a suitable braking arrangement for a particular use environment. The wheel brakes 102 are described herein as comprising first and second pairs of wheel brakes 102, with the first and second pairs being characterized as RF/LR and LF/RR, as shown as FIG. 1, for the sake of description. However, LF/LR and RF/RR, or RF/LF and RR/LR, pairs could also or instead be specified for the brake system 100, as desired.

Also for the sake of description, it is presumed that a deceleration signal transmitter (shown schematically at 104) is configured to provide a braking signal, in a wired or wireless manner, corresponding to a desired braking action by an operator of the vehicle. The deceleration signal transmitter 104 could include, but not be limited to, a brake pedal, an autonomous braking controller, and/or any other suitable scheme for generating a braking signal from which the brake system 100 can be actuated.

The brake systems 100 also include a fluid reservoir 106. The reservoir 106 stores and holds hydraulic fluid for the brake system 100. The fluid within the reservoir 106 is preferably held at or about atmospheric pressure, but the fluid may be stored at other pressures if desired. The reservoir 106 is shown schematically as having three tanks or sections in FIG. 1, with fluid conduit lines connected thereto. The sections can be separated by several interior walls within the reservoir 106 and are provided to prevent complete drainage of the reservoir 106 in case one of the sections is depleted due to a leakage via one of the three lines connected to the reservoir 106. Alternatively, the reservoir 106 may include multiple separate housings. The reservoir 106 may include at least one fluid level sensor 108 for detecting the fluid level of one or more of the sections of the reservoir 106.

A motor-driven master cylinder (“MC” or “[primary] power transmission unit”) 110 (which may be a dual-chamber type master cylinder 110, also known as a tandem power transmission unit) of each brake system 100 functions as a source of pressure to provide a desired pressure level to the hydraulically operated wheel brakes 102 during a typical or normal non-failure brake apply. An example of a suitable MC 110 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes. The master cylinder 110 is operable during a normal non-failure braking mode by actuation of an electric motor 112 of the master cylinder 110 to generate brake actuating pressure at first and second MC outputs 114 and 116, respectively, for hydraulically actuating the first and second pairs of wheel brakes 102.

After a brake apply, fluid from the wheel brakes 102 may be returned to the master cylinder 110 and/or be diverted to the reservoir 106. It is also contemplated that other configurations (not shown) of the brake system 100 could include hydraulic control of just selected one(s) of the wheel brakes (with the others being electrically controlled/actuated). One of ordinary skill in the art would be readily able to provide such an arrangement for a desired use environment, following aspects of the present invention.

An iso/dump control valve arrangement is associated with each wheel brake 102 of the plurality of wheel brakes 102. Each iso/dump control valve arrangement includes an iso valve 118 and a dump valve 120, for providing desired fluid routing to an associated wheel brake 102. The reservoir 106 is hydraulically connected to the master cylinder 110 and to each of the iso/dump control valve arrangements, such as via the return line 136. The iso/dump control valve arrangements each include respective serially arranged iso and dump valves 118 and 120. The normally open iso valve 118 for each iso/dump control valve arrangement is located hydraulically between a respective wheel brake 102 and the master cylinder 110, and the normally closed dump valve 120 for each iso/dump control valve arrangement is located hydraulically between a respective wheel brake 102 and the reservoir 106, for the corresponding wheel brake 102.

The iso/dump control valve arrangements may selectively provide slip control to at least one wheel brake 102 powered by the master cylinder 110 and/or the secondary brake module described below. More broadly, the iso/dump control valve arrangement, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 122 is hydraulically interposed between the master cylinder 110 and at least one iso/dump control valve arrangement via the first MC output 114. A second traction control iso valve 124 is hydraulically interposed between the master cylinder 110 and at least one iso/dump control valve arrangement via the second MC output 116. As shown in the Figures, it is contemplated that an iso/dump control valve arrangement may be associated with each wheel brake 102 of the first and second pairs of wheel brakes. The first traction control iso valve 122 is hydraulically interposed between the motor-driven master cylinder 110 and the iso/dump control valve arrangements of the first pair of wheel brakes 102. Similarly, the second traction control iso valve 124 is hydraulically interposed between the motor-driven master cylinder 110 and the iso/dump control valve arrangements of the second pair of wheel brakes 102.

A pump piston 126 is associated with at least one wheel brake 102 of the plurality of wheel brakes 102. The pump piston 126 is driven by an electric PTU motor 128 (as differentiated from the electric motor 112 included in the master cylinder 110) which transmits rotary motion to each pump piston 126 for selectively providing pressurized hydraulic fluid to the iso/dump control valve arrangement of at least one wheel brake 102 which is associated with the pump piston 126. FIG. 1 shows one pump piston 126 as being associated with two wheel brakes 102, for a total of two pump pistons 126 in the brake system 100. Together, the pump piston(s) 126 and electric PTU motor 128 can be considered to comprise a secondary brake module of the brake system 100. For example, the two pump pistons 126 shown in the Figures may provide pressurized hydraulic fluid at first and second pump outputs 130 and 132, respectively, to the corresponding wheel brakes 102 via the corresponding iso/dump control valve arrangements (when present), to actuate the first and second pairs of wheel brakes 102 in at least one of a normal non-failure braking mode and a backup braking mode. Each of the first and second pump outputs 130 and 132 can provide fluid to a corresponding one of the first and second pairs of wheel brakes 102. It is contemplated that a plurality of pump pistons 126 could be associated with each of the first and second pump outputs 130 and 132, in some configurations of the brake system 100.

The secondary brake modules (A.K.A. “secondary brake modules”) of the brake systems 100 function as a source of pressure to provide a desired pressure level to selected ones of the wheel brakes 102 in a backup or “failed” situation, when, for some reason, the master cylinder 110 is unable to provide fluid to those selected wheel brakes 102. Accordingly, each of the secondary brake modules is directly fluidly connected to the reservoir 106, for exchanging hydraulic fluid between these components without having to route the fluid through a (potentially failed) motor-driven master cylinder 110 or another structure of the brake system 100.

The secondary brake modules can be used to selectively provide hydraulic fluid to at least one of the wheel brakes 102 in a backup braking mode, but also in an enhanced braking mode, which can occur on its own and/or concurrently with either the backup braking mode or a non-failure normal braking mode. Examples of suitable enhanced braking mode functions available to the brake systems 100 include, but are not limited to, “overboost” (in which higher pressure is provided to a particular brake than would normally be available from the master cylinder 110 alone) and “volume-add” (in which more fluid is provided to a particular brake than would normally be available from the master cylinder 110). 126. For example, in at least one of the normal non-failure braking mode and the backup braking mode, the secondary brake module can then supply boosted-pressure (above what was obtained from the master cylinder 110) hydraulic fluid to at least one of the first and second pump outputs 130 or 132.

As can be seen, each iso/dump control valve arrangement in the brake systems 100 shown in the Figures is in direct or indirect fluid communication with both a selected one of the first and second MC outputs 114 and 116 and a selected one of the first and second pump outputs 130 and 132 for selectively receiving pressurized fluid therefrom, such as during different braking modes or otherwise as desired. One of ordinary skill in the art will be readily able to configure a brake system 100 for any particular use application as desired.

The brake system 100 shown in FIG. 1 also includes at least one electronic control unit (“ECU”) 134, for controlling at least one of the master cylinder 110 and the secondary brake module (via electric PTU motor 128) responsive to at least one brake pressure signal, with first and second ECUs 134A, 134B being shown and described herein. The ECUs 134A, 134B may include microprocessors and other electrical circuitry. The ECUs 134A, 134B receive various signals, process signals, and control the operation of various electrical components of a corresponding brake system 100 in response to the received signals, in a wired and/or wireless manner. The ECUs 134A, 134B can be connected to various sensors such as the reservoir fluid level sensor(s) 108, pressure sensors, travel sensors, switches, wheel speed sensors, and steering angle sensors. The ECUs 134A, 134B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 134A, 134B may be connected to the instrument cluster for collecting and supplying information related to warning indicators such as an ABS warning light, a brake fluid level warning light, and a traction control/vehicle stability control indicator light. It is contemplated that at least one of the ECUs 134A and 134B may be, for example, integrated with the master cylinder 110 or the electric PTU motor 128.

The first and second ECUs 134A and 134B may divide the control tasks for the brake system 100 in any desired manner, and may be readily configured by one of ordinary skill in the art for a particular use environment of a brake system, though it is contemplated that any control tasks performed by one or more ECUs 134 will be accomplished responsive to at least one brake pressure signal and/or a braking signal produced by the deceleration signal transmitter 104. For example, the first ECU 134A may be operative to control the electric motor 136 of the master cylinder 110. The second ECU 150 4B may be operative to control the electric PTU motor 128, at least one of the iso/dump control valve arrangements, and at least one of the first and second traction control iso valves 122, 124.

A “brake pressure signal” is referenced above as being at least one input that an ECU 134 may consider and responsively control one or more other components of the brake system 100, to achieve desired braking results for a particular use environment. One potential source of the brake pressure signal is a brake pressure sensor. For example, and as shown in the Figures, the brake system 100 can include at least one, such as at least two, brake pressure sensors 138 (four shown), with each brake pressure sensor 138 optionally (and as shown) being located directly hydraulically adjacent a corresponding wheel brake 102 for sensing hydraulic pressure at the corresponding wheel brake 102 and responsively producing a brake pressure signal. In other words, in the brake system 100 shown in FIG. 1, there is no other component interposed hydraulically between a brake pressure sensor 138 and its corresponding wheel brake 102, so that the brake pressure signal produced by each brake pressure sensor 138 correlates with an actual sensed brake pressure at the corresponding wheel brake 102.

A first bypass iso valve 140 is hydraulically interposed between the first traction control iso valve 122 and a front brake of the first pair of wheel brakes 102, in parallel with the iso/dump control valve arrangement corresponding to the front brake of the first pair of wheel brakes 102. A second bypass iso valve 142 is hydraulically interposed between the second traction control iso valve 124 and a front brake of the second pair of wheel brakes 102, in parallel with the iso/dump control valve arrangement corresponding to the front brake of the second pair of wheel brakes 102. The first and second bypass iso valves 140 and 142 shown in FIG. 1 are shown as being normally open iso valves.

As can be seen in the Figures, a first brake pressure sensor 138A may be interposed hydraulically between the first bypass iso valve 140 and a corresponding front wheel brake of the first pair of wheel brakes 102, and a second brake pressure sensor 138B may be interposed hydraulically between the second bypass iso valve 142 and a corresponding front wheel brake of the second pair of wheel brakes 102. One of ordinary skill in the art can readily provide a desired number/position/type of pressure sensors 138 for a particular brake system 100.

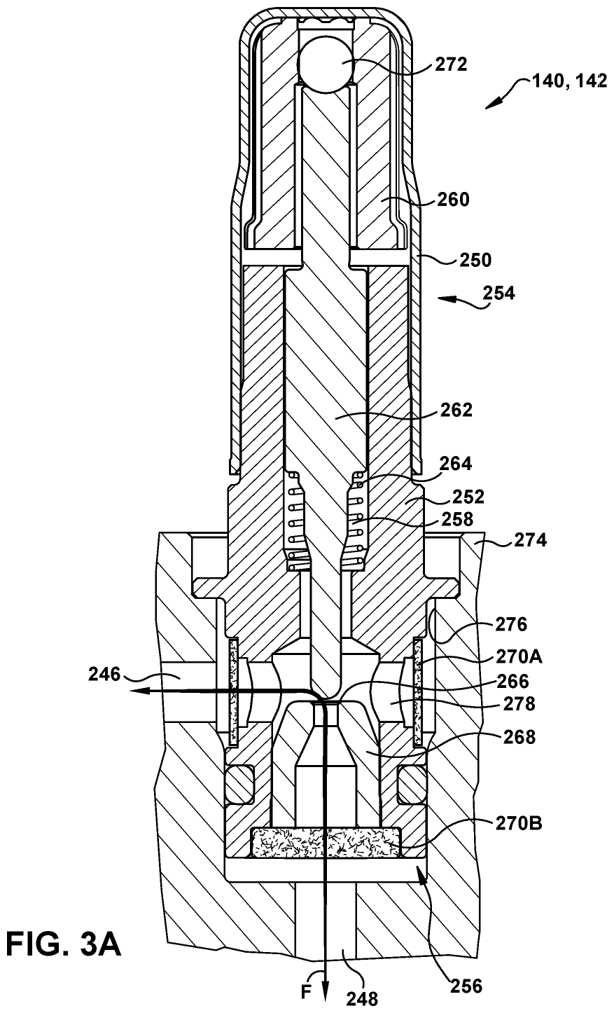

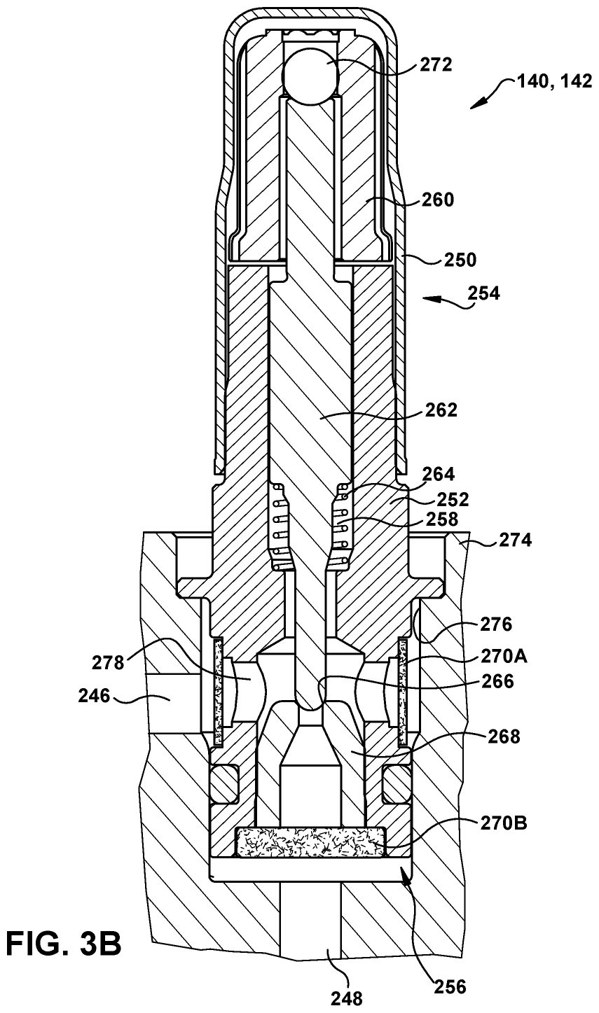

The first and second bypass iso valves 140 and 142 are configured to close responsive to higher hydraulic fluid pressure on an upstream (i.e., closer to the master cylinder 110) side of the respective bypass iso valves 140 and 142, to facilitate the brake system 100 holding the first and second bypass iso valves 140 and 142 closed with relatively low current draw on the system. The first and second bypass iso valves 140 and 142 also have a larger orifice size than an orifice size of the iso valve 118 of the corresponding iso/dump control valve arrangement, and are oriented in an opposite fluid flow direction as is the iso valve 118 of the corresponding iso/dump control valve arrangement (i.e., plumbed in a “reverse” direction to the corresponding iso valves 118). As a result, the first and second bypass iso valves 140 and 142 can thus help pressurize the wheel brakes 102 quickly during a “spike apply” situation. (It should be noted that the first and second bypass iso valves 140 and 142 may also have a larger orifice size than an orifice size of the corresponding first and second traction control iso valves 122 and 124, as well.) An example of usage of the first and second bypass iso valves 140 and 142 is that an undesirably large pressure spike can occur once an iso valve 118 closes, since the electric motor 112 of the master cylinder 110 has inertia and takes a predetermined amount of time to stop spinning and driving the piston in the chamber of the master cylinder 110. Presence of the first and second bypass iso valves 140 and 142 in handling a “spike apply” situation also allows the use of a smaller corresponding iso valve 118 because the electric motor 112 won't need to rotate as quickly to achieve a desired amount of fluid pressure at the associated wheel brake 102 than if the iso valve 118 were larger. The structure of the first and second bypass iso valves 140 and 142 will be discussed in more detail below with reference to FIGS. 3A-3B.

An electric brake motor 144 may be associated with each of the rear wheel brakes of the front and rear pairs of wheel brakes 102. When present, the electric brake motors 144 may be operative in at least the backup braking mode and may be controlled by an opposite ECU 134 (responsive to the braking signal) as is the electric motor 112 of the master cylinder 110, when multiple ECUs 134 are present. For example, when the first ECU 134A controls the electric motor 112 of the master cylinder 110, the second ECU 134B may control the electric PTU motor 128 and the electric brake motors 144, for redundancy in the brake system 100 if the first ECU 134A should fail.

The brake systems of FIGS. 1-2 and 6 also include a low pressure accumulator 148 interposed hydraulically between the first and second pairs of wheel brakes 102. For example, the low pressure accumulator 148 can be placed in direct fluid communication with the pump pistons 126 of the secondary brake module and with the dump valves 120 of the iso/dump control valve arrangements, as shown in the Figures.

When present, the low pressure accumulator 148 is in indirect fluid communication with the reservoir 106 via the first and second MC outputs 114 and 116 and the master cylinder 110. That is, the low pressure accumulator 148 is not directly connected to the reservoir 106 in the brake systems 100 of FIGS. 1-2 and 6, and there is no return line for the low pressure accumulator 148 because the low pressure accumulator 148 stores fluid as-needed adjacent the secondary brake module. The low pressure accumulator 148 may at least partially provides slip control to the first and second pairs of wheel brakes 120 in coordination with the secondary brake module when the brake system 100 is in the normal non-failure braking mode.

Known brake systems use the secondary brake module to either pull fluid down high-pressure brake pipes from the reservoir 106 or pull fluid down a low-pressure hose (“return line”). The brake pipe solution struggles with performance at cold temperatures and/or high altitudes. By storing fluid in the low pressure accumulator 148, desired performance can be achieved while still omitting the low-pressure hose from the brake system 100. The low pressure accumulator 148 (A.K.A. “fluid storage accumulator”) can assist with slip control.

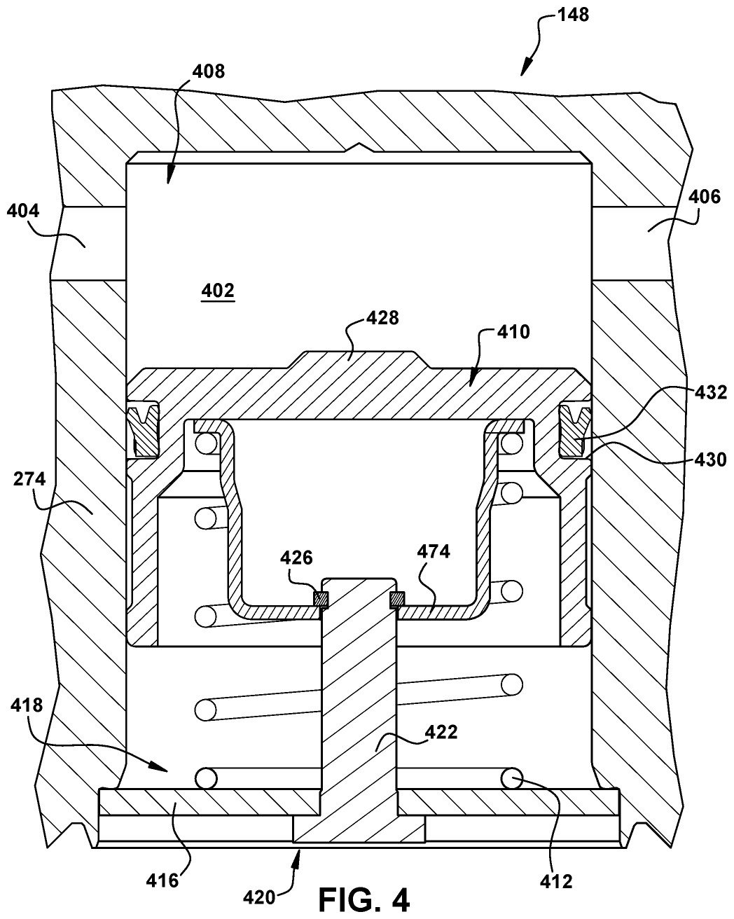

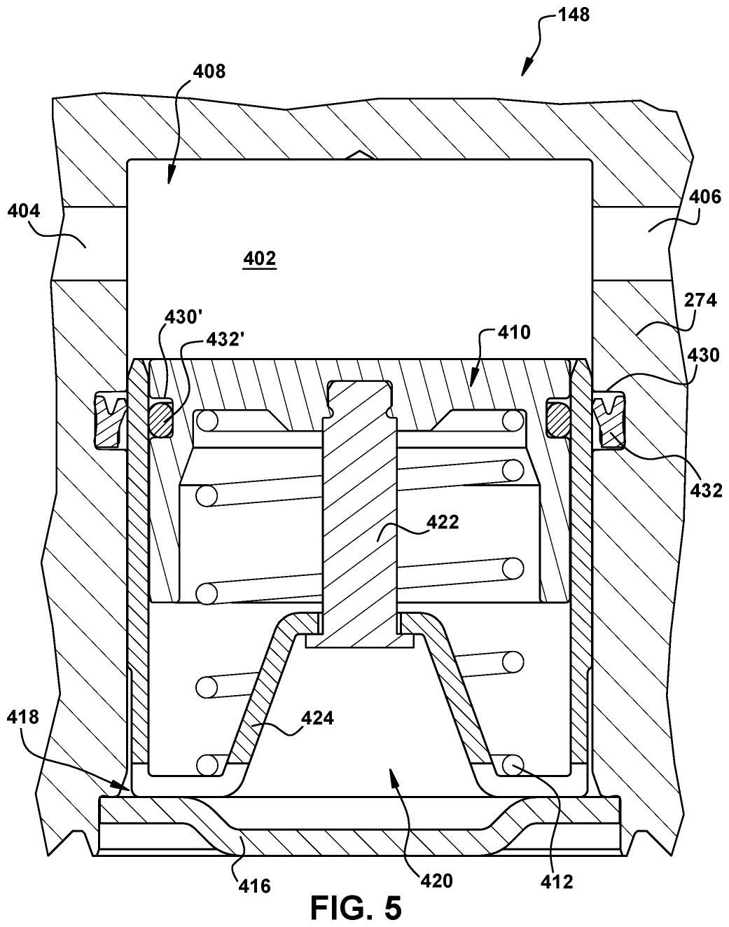

Switches or sensors (e.g., LPA switch 150) can be provided to detect, and responsively report to the electronic control unit(s) 134, a fluid level in the low pressure accumulator 148. For example, the LPA switch 1050 may detect when the low pressure accumulator 148 is substantially empty and fluid has been removed from the fluid storage portion of the low pressure accumulator 148. Example low pressure accumulators 148 for use with any suitable brake system 100 will be described below, with reference to FIGS. 4-5.

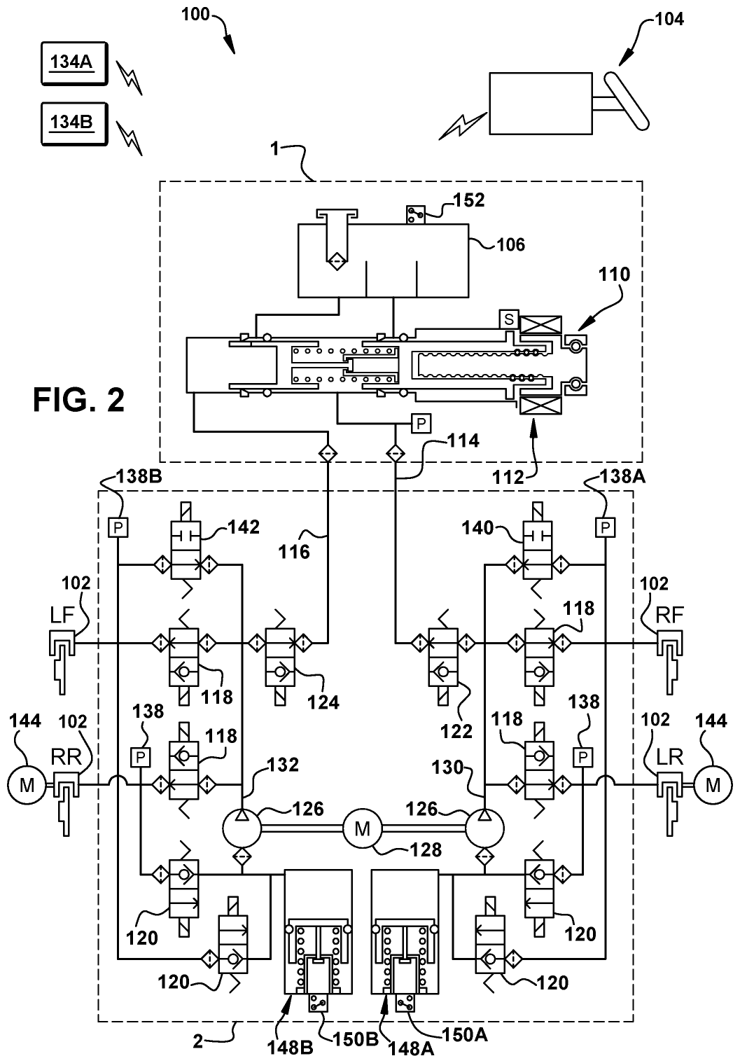

FIG. 2 illustrates a second embodiment of a brake system 100. The brake system of FIG. 2 is similar to the brake system of FIG. 1, and therefore, structures of FIG. 2 that are the same as or similar to those described with reference to FIG. 1 have the same reference numbers. Description of common elements and operation similar to those in the previously described first embodiment will not be repeated with respect to the second embodiment, but should instead be considered to be incorporated below by reference as appropriate.

In the brake system 100 of FIG. 2, the low pressure accumulator is a first low pressure accumulator 148A, and the brake system 100 includes a second low pressure accumulator 148B spaced hydraulically apart from the first low pressure accumulator 148A by the secondary brake module, as shown. Stated otherwise, the first and second low pressure accumulators 148A and 148B are not directly connected to each other, but instead each exchange hydraulic fluid with a separate “side” of the brake system 100. As shown in FIG. 2, each of the first and second low pressure accumulators 148A and 148B is operative to selectively regulate hydraulic fluid for a corresponding first or second pair of wheel brakes 102. It should be noted that, because of the plurality of low pressure accumulators 148 being provided to the brake system 100 of FIG. 2, (a) each low pressure accumulator 148 can be smaller than if there were only a single low pressure accumulator 148 provided, and/or (b) a fluid level switch 152 can be provided at the reservoir 106, rather than the fluid level sensor 108 of other embodiments of the brake system 100, which may result in cost and/or complexity savings for the system. Since there is no linkage of the low pressure accumulator(s) 148 directly to the reservoir 106 (instead, fluid must be routed through the master cylinder 110), the low pressure accumulator(s) 148 should be configured to hold sufficient fluid to operate the wheel brakes 102 as desired even if fluid is not available for supply via the master cylinder 110.

One of ordinary skill in the art will be able to readily configure a brake system 100 according to any embodiment of the present invention, including one or more low pressure accumulators 148 for a particular use environment. For example, fluid volume from the low pressure accumulator 148 can be provided to the secondary brake module during situations including, but not limited to, spike apply, high system pressures (e.g., above about 180 bar), and/or a failed master cylinder 110. During slip control of a normal non-failure braking mode, the low pressure accumulator(s) 148 can be used to at least partially attenuate pressure spikes within the brake system 100, as well.

FIGS. 3A-3B will be described below as pertaining to the first bypass iso valve 140 for simplicity, but the second bypass iso valve 142 will be structured similarly, in many use environments. FIG. 3A depicts the bypass valve 140, 142 in an open condition, and the bypass valve 140, 142 is energized closed in FIG. 3B. With reference to FIGS. 3A-3B, the first and second bypass iso valves 140 and 142 may each include an MC passage 246 in fluid communication with a corresponding first or second MC output 114, 116, a brake-side passage 248 in fluid communication with a corresponding front wheel brake 102, and a longitudinally extending bypass valve sleeve 250. The MC passage 246 may be in indirect fluid communication with the corresponding first or second MC output 114, 116 via a corresponding first or second traction control iso valve 122, 124. The brake-side passage 248 may be in direct fluid communication with the corresponding front wheel brake 102. One of ordinary skill in the art can readily configure a brake system 100 including one or more bypass iso valves 140 and 142, for a particular use environment.

A bypass valve body 252 has longitudinally spaced first and second body ends 254 and 256, respectively, with a bypass body lumen 258 extending therebetween. The bypass valve body 252 spaces at least a portion of the bypass valve sleeve 250 (which at least partially surrounds the first body end 254) away from at least the brake-side passage 248, which is located adjacent the second body end 256. A bypass armature 260 is located within the bypass valve sleeve 250 adjacent the first body end 256. A bypass tappet 262 is at least partially surrounded by the bypass armature 260 and the bypass valve sleeve 250. The bypass tappet 262 extends at least partially through the bypass body lumen 258. The bypass tappet 262 is selectively moved longitudinally within the bypass body lumen 258 toward the bypass valve body 252 via energization of the bypass armature 260. A bypass biasing spring 264 is mechanically interposed between the bypass tappet 262 and at least a portion of the bypass valve body 252 within the bypass body lumen 258. The bypass biasing spring 264 is operative to bias the bypass tappet 262 toward the first body end 254. A bypass valve seat 266 is carried by a bypass seat body 268 located directly adjacent the second body end 256.

Any desired number of bypass valve filters 270 can be provided and are shown here as a band filter 270A and a disc filter 270B, associated with the MC passage 246 and the brake-side passage 248, respectively. An air gap spacer 272 may be provided to assist with keeping tolerances, adjusting a magnetic air gap, and/or transferring forces between components as desired. The bypass valve 140, 142 may be carried by a housing block 274 of a brake system 100, and at least a portion of the MC passage 246 and the brake-side passage 248 may be formed within the housing block 274. The bypass valve body 252, or any other desired components of the bypass valve 140, 142 may be maintained within a valve bore 276 of the housing block 274 through staking, crimping, welding, soldering, adhesive, fasteners, or any other desired maintenance scheme.

A bypass valve fluid path F extends (in a bidirectional manner) through a selected one of the MC passage 246 and the brake-side passage 248, past the bypass valve seat 266, through at least one laterally extending side aperture 278 in the bypass valve body 252, through at least a portion of the bypass body lumen 258, and through the other one of the MC passage 246 and the brake-side passage 248 to place these two passages in fluid communication. This is the “normally open” position shown in FIG. 3A.

In the “energized closed” position shown in FIG. 3B, the bypass tappet 262 selectively engages with the bypass valve seat 266 to substantially occlude the bypass valve fluid path F responsive to energization of the bypass armature 260 moving the bypass tappet 262 toward the second body end 256.

Examples of two arrangements of suitable low pressure accumulators that can be used in any of the brake systems 100 of FIGS. 1-2 and 6 (or with any other brake systems, as desired) are shown in FIGS. 4-5.

With reference first to FIG. 4, the low pressure accumulator 148 includes an LPA cavity 402 including at least one brake-side passage (shown here as first and second brake-side passages 404 and 406, respectively) adjacent a first end 408 of the LPA cavity 402. It is contemplated that, particularly for brake systems 100 having multiple low pressure accumulators 148, there may be only one brake-side passage, but a dual-passage version of the low pressure accumulator 148 is shown in FIGS. 4-5 by way of example. In these Figures, the first brake-side passage 404 may be in fluid communication with an inlet of the pump piston 126 and the second brake-side passage may be in fluid communication with the dump valves 120 of the iso/dump control valve arrangements, as shown in use for the brake system 100 of FIG. 1. An LPA piston 410 is provided for reciprocal longitudinal motion within the LPA cavity 402 responsive to a predetermined amount of hydraulic fluid flow through the brake-side passage (here, at least one of the first and second brake-side passages 404 and 406).

An LPA biasing spring 412 is provided for urging the LPA piston 410 toward the first end 408 of the LPA cavity 402. The hydraulic fluid flow will need to overcome the biasing force of the LPA biasing spring 412 to push the LPA piston 410 longitudinally downward (in the orientation of FIG. 4) and thus store hydraulic fluid within the “wet side” (i.e., above the LPA piston 410 face, the area labeled “W”) of the low pressure accumulator 148. The “dry side” of the low pressure accumulator 148 is shown as being the area below the LPA piston 410, in the orientation of FIG. 4, and is labeled “D”. This “dry side” area is vented to atmosphere—for example, through a passageway (not shown) including a Gore or other liquid-impermeable but gas-permeable membrane, in any suitable position with respect to the low pressure accumulator 148 and the vent may be located in fluid communication with at least a portion of the electronic control unit 134, in some use environments. A retainer disc 416 may be located adjacent the membrane 414 (when present) at a second end 418 of the LPA cavity 402, and the LPA biasing spring 412 can contact the retainer disc 416 as a “base” from which to exert an upward (in the orientation of FIG. 4) biasing force on the LPA piston 410.

An LPA limiter (shown generally at 420), including an LPA rod 422 and an LPA cage 424, may be provided for selectively limiting longitudinal travel of at least one of the LPA biasing spring 412 and the LPA piston 410. The LPA cage 424 can be pushed upward by the LPA biasing spring 412, into the position shown in FIG. 4, where a retainer clip 426 prevents further upward travel of the LPA cage 424. (The LPA rod 422 can help guide and stabilize travel of the LPA cage 424 within the LPA cavity 402.) Conversely, the LPA cage 424 may block further downward travel of the LPA piston 410, in concert with the LPA biasing spring 412, and/or a lower skirt of the LPA piston 410 can contact the retainer disc 416 to prevent travel of a face of the LPA piston 410 beyond a predetermined “bottomed out” position within the LPA cavity 402.

The LPA rod 422 may be connected to a selected one of the LPA piston 410 and—as depicted schematically in FIG. 4—the second end 418 of the LPA cavity 402, longitudinally spaced from the first end 408. The LPA cage 424 is permitted to move longitudinally with respect to the selected one of these two structures. A holdoff 428 may be provided to prevent an entirety of the face of the LPA piston 410 from directly contacting an end surface of the first end 408 of the LPA cavity 402. One of ordinary skill in the art can readily provide a suitably configured low pressure accumulator 148 for a particular use environment of the brake system 100. However configured, the low pressure accumulator 148 is configured for a variable-volume “wet” area (W) which can be used in a non-powered, mechanical manner, to hold varying amounts of hydraulic fluid, as desired for a particular brake system 100.

With reference again to FIG. 4, the LPA piston 410 may include a circumferential LPA seal groove 430 about a head portion thereof. A directional LPA seal 432 may be carried within the LPA seal groove 430 longitudinally reciprocally with respect to an inner wall of the LPA cavity 402 for preventing fluid flow longitudinally therepast. When present, the directional LPA seal 432 may provide a longitudinally moving delineation line between the wet and dry sides of the LPA cavity 402. If the LPA piston 410 should “float” upward (in the orientation of FIG. 4) above the extent of the constrained, caged LPA biasing spring 412, then the directional LPA seal 432 can provide a friction force to resist movement of the LPA piston 410 and thus prevent free-sliding of the LPA piston 410 within the LPA cavity 402. In the FIG. 4 embodiment of the low pressure accumulator 148, the LPA rod 422 is maintained in position relative to the LPA cavity 402 as the LPA piston 410 reciprocates longitudinally within the LPA cavity 402.

In contrast, the low pressure accumulator 148 of FIG. 5—while in some respects similar to that of FIG. 4—has an LPA cavity 402 which includes a circumferential LPA seal groove 430 in an inner wall of the LPA cavity 402 and spaced longitudinally (vertically, in the orientation of FIG. 5) between first and second ends 408 and 418 of the LPA cavity 402. While this cavity-located LPA seal groove 430 requires more internal machining of the housing block 274 for the FIG. 5 embodiment than for the FIG. 4 embodiment, it may be suitable to undertake such extra effort to achieve the multi-stage motion of the LPA piston 410 that is provided with the low pressure accumulator of FIG. 5. In the embodiment shown in FIG. 5, a directional LPA seal 432 is located within the LPA seal groove 410 for preventing fluid flow longitudinally therepast during reciprocal motion of the LPA piston 410 within the LPA cavity 402—likewise, at least partially separating the “wet” and “dry” sides of the LPA cavity 402.

For the low pressure accumulator 148 shown in FIG. 5, it can be seen that at least a portion of the LPA cage 424 is interposed laterally between the LPA piston 410 and the inner wall of the LPA cavity 402, for sliding motion with respect to both—again, facilitating a multi-stage or multi-motion actuation of the low pressure accumulator 148 of FIG. 5. To that end, the LPA piston 410 includes a circumferential LPA seal groove 430′ about a head portion thereof and a nondirectional second LPA seal 432′ within the LPA seal groove 430′ for sliding longitudinally reciprocally with respect to an inner wall of the LPA cage 424 for preventing fluid flow longitudinally therepast. The nondirectional second LPA seal 432′ may, for example, have a substantially circular or ovoid cross-sectional shape, which can assist with providing a desired direction and amount of frictional force on adjacent components of the low pressure accumulator.

As can be seen in FIG. 5, neither the LPA cage 424 nor the LPA rod 422 depicted is anchored or maintained at the second end 418 of the LPA cavity 402. Instead, the entire LPA limiter 420 (i.e., the LPA rod 422 and the LPA cage 424) is configured to reciprocate within the LPA cavity 402 substantially along with the LPA piston 410. That said, it should be noted that the LPA biasing spring 412 pushes longitudinally against both the LPA cage 424 and the LPA piston 410 to urge those structures apart, but that the LPA cage 424 holds a bottom flange of the LPA rod 422 to prevent more than a predetermined amount of longitudinal separation between the LPA cage 424 and the LPA piston 410—since the top end of the LPA rod 422 is held by the LPA piston 410. (This predetermined amount of longitudinal separation is shown schematically in FIG. 5, with the low pressure accumulator 148 being shown in a resting position.) However, the LPA piston 410 is permitted, in the arrangement of FIG. 5, to travel longitudinally downward, against the LPA biasing spring 412 force, until the LPA rod 422 “bottoms out” against the retainer disc 416 and/or until a lower skirt of the LPA piston 410 contacts an inner bottom rim of the LPA cage 424, either of which will prevent further downward travel of the LPA piston 410.

The low pressure accumulator 148 of FIG. 5 may be desirable in certain use environments, as opposed to the low pressure accumulator of FIG. 5, because the low pressure accumulator 148 of FIG. 5 includes the dual-seal arrangement shown in that Figure. In the design shown in FIG. 5, most of the LPA function is provided by the second LPA seal 432′, and the first LPA seal 432 is seldom used as a dynamic seal. The second LPA seal 432′ can be a high-friction seal. Conversely, in the design shown in FIG. 4, all of the LPA dynamic sealing function is accomplished by the LPA seal 432 alone, and more leakage past the LPA seal 432 is possible with the very low-friction seal used in the low pressure accumulator 148 of FIG. 4. Regardless of the specific configuration of a low pressure accumulator 148 for use with the present brake systems 100, however, one of ordinary skill in the art will be readily able to provide a suitable arrangement for a particular use environment, according to the present invention.

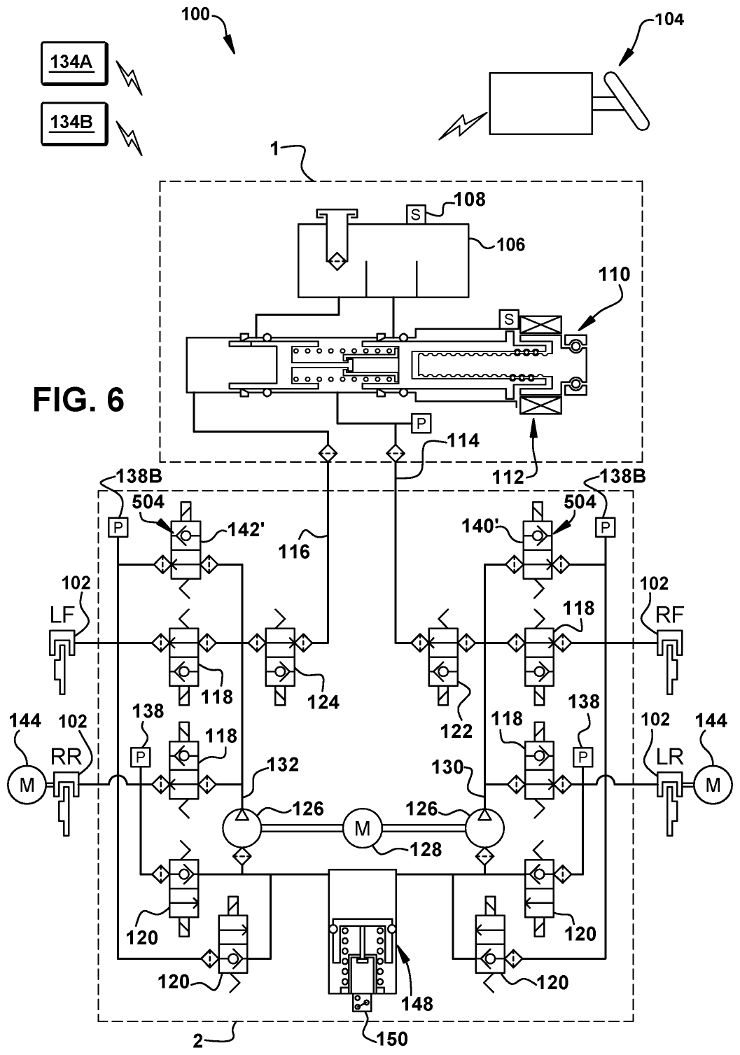

FIG. 6 illustrates a third embodiment of a brake system 100. The brake system of FIG. 6 is similar to the brake systems of FIGS. 1-2, and therefore, structures of FIG. 6 that are the same as or similar to those described with reference to FIGS. 1-2 have the same reference numbers. Description of common elements and operation similar to those in the previously described first and second embodiments will not be repeated with respect to the third embodiment, but should instead be considered to be incorporated below by reference as appropriate.

In the brake system 100 of FIG. 6, each of the first and second bypass iso valves 140′ and 142′ is a same iso valve type as is the iso valve 118 of the corresponding iso/dump control valve arrangement (rather than being the FIG. 3A-3B bypass iso valve 140, 142 of the first and second embodiments of the brake systems 100 shown in FIGS. 1-2). That is, in the second embodiment of the brake system 100 shown in FIG. 6, each of the first and second bypass iso valves 140′ and 142′ includes a check valve mechanism 504 selectively permitting fluid flow therethrough. Each of the first and second bypass iso valves 140′ and 142′ is configured to open responsive to higher hydraulic fluid pressure on an upstream (i.e., closer to the master cylinder 110) side of the bypass valve 140′ and 142″—again, in contrast with the FIG. 1 arrangement. The brake system 100 shown in FIG. 5 may be simpler to construct than that of FIG. 1, because the FIG. 5 brake system includes one fewer type of valve to be provided and configured. It is contemplated that any desired number of low pressure accumulators 148 can be provided to a brake system 100 having any desired type of bypass iso valves, and one of ordinary skill in the art will be readily able to configure a suitable brake system for a particular use environment.

With reference now to FIGS. 1-2 and 6, the reservoir 106 and motor-driven master cylinder 110 may be co-located in a first housing (indicated schematically by dashed line “1” in those Figures), and the secondary brake module may be located in a second housing (indicated schematically by dashed line “2” in those Figures), spaced apart from the first housing. Optionally, and also as shown in FIG. 1, the iso/dump control valve arrangements, the first and second bypass iso valves 140 and 142, any desired low pressure accumulators 148, and/or the first and second traction control iso valves 122 and 124 may also be located in the second housing.

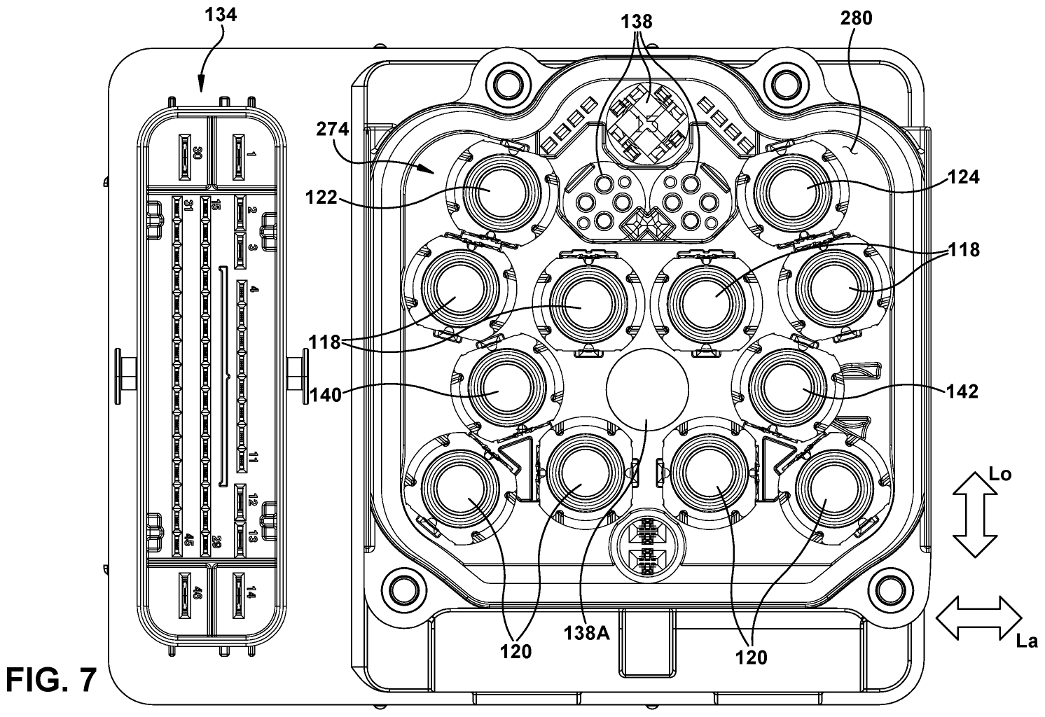

With reference now to FIG. 7, a plurality of components of the brake system 100 are housed in a common block housing 274 having a housing face 280 extending in a longitudinal-lateral plane (i.e., parallel to the plane of the page in FIG. 7). The “longitudinal” direction, in FIG. 7, is substantially vertical and is indicated by arrow “Lo”; the “lateral” direction, in FIG. 7, is substantially horizontal and is indicated by arrow “La”. Each of the first and second bypass iso valves 140 and 142 is located longitudinally between iso and dump valves 118 and 120 of a corresponding iso/dump valve arrangement. This placement of the first and second bypass iso valves 140 and 142 is where the supply valves would be normally located, in prior art brake systems.

A pressure sensor 138A is interposed directly laterally between the first and second bypass iso valves 140 and 142, above the pump drive bearings in the brake system 100. It should be noted that prior art brake systems only make provision for three pressure sensors (labeled as 138 in FIG. 7). In the FIG. 7 brake system 100 described here, it may be desirable to add in a fourth pressure sensor 138A while maintaining a compact layout for the system; hence this placement for pressure sensor 138A. As shown in FIG. 7, the pressure sensors 138 on the centerline of the block housing 274 (with one of them being over the motor bearings) are associated with the front brakes, and the other two (non-centerline located) pressure sensors 138 are associated with the rear brakes. However, it is contemplated that one of ordinary skill in the art can readily provide any desired number, type, placement, or otherwise configured pressure sensor(s) for a particular use environment for a brake system 100.

The first and second housings (and included/co-located components) of any brake systems 100 may be provided and configured for a particular use application by one of ordinary skill in the art based upon factors including, but not limited to, achieving desired outcomes in at least one of design, manufacturing, service, spatial utilization in the vehicle, cost, size, regulatory compliance, or the like.

It is contemplated that various other components, such as electric service and/or parking brake motors, could be provided by one of ordinary skill in the art to achieve desired configurations for particular use environments, in any of the brake systems described herein. For example, while a number of filters and pressure or other sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary brake module configured for selectively providing pressurized hydraulic fluid at first and second PTU outputs for actuating the first and second pairs of wheel brakes in at least one of a normal non-failure braking mode and a backup braking mode, the secondary brake module including an electric PTU motor configured to selectively pressurize the hydraulic fluid by transmitting rotary motion to at least two pump pistons, each pump piston providing pressurized hydraulic fluid to a corresponding one of the first and second PTU outputs, each of the first and second PTU outputs providing fluid to a corresponding one of the first and second pairs of wheel brakes;
a low pressure accumulator interposed hydraulically between the first and second pairs of wheel brakes, the low pressure accumulator being in indirect fluid communication with the reservoir via the first and second MC outputs and the master cylinder; and
an electronic control unit for controlling at least one of the secondary brake module and the master cylinder responsive to at least one brake pressure signal;
wherein the low pressure accumulator at least partially provides slip control to the first and second pairs of wheel brakes in coordination with the secondary brake module when the brake system is in the normal non-failure braking mode.

2. The brake system of claim 1, including an iso/dump control valve arrangement associated with each wheel brake of the plurality of wheel brakes, each iso/dump control valve arrangement being controlled by the electronic control unit.

3. The brake system of claim 2, wherein each iso/dump control valve arrangement is in fluid communication with both a selected one of the first and second MC outputs and a selected one of the first and second PTU outputs for selectively receiving pressurized hydraulic fluid therefrom.

4. The brake system of claim 1, wherein a first brake pressure sensor is interposed hydraulically between the first MC output and a corresponding first pair of wheel brakes and a second brake pressure sensor is interposed hydraulically between the second MC output and a corresponding second pair of wheel brakes.

5. The brake system of claim 1, wherein the secondary brake module includes a plurality of pump pistons associated with each of the first and second PTU outputs.

6. The brake system of claim 1, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet.

7. The brake system of claim 6, including an iso/dump control valve arrangement associated with each wheel brake of the first and second pairs of wheel brakes, wherein the first traction control iso valve is hydraulically interposed between the motor-driven master cylinder and the iso/dump control valve arrangements of the first pair of wheel brakes, and wherein the second traction control iso valve is hydraulically interposed between the motor-driven master cylinder and the iso/dump control valve arrangements of the second pair of wheel brakes.

8. The brake system of claim 7, including a first normally open bypass iso valve hydraulically interposed between the first traction control iso valve and a front brake of the first pair of wheel brakes, and including a second normally open bypass iso valve hydraulically interposed between the second traction control iso valve and a front brake of the second pair of wheel brakes, wherein each of the first and second bypass iso valves has a larger orifice size than an orifice size of the iso valve the corresponding iso/dump control valve arrangement.

9. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves is a normally open iso valve and is configured to close responsive to higher hydraulic fluid pressure on an upstream (i.e., closer to the master cylinder) side of the bypass valve.

10. The brake system of claim 8, wherein each of the first and second bypass iso valves is configured to open responsive to higher hydraulic fluid pressure on an upstream (i.e., closer to the master cylinder) side of the bypass valve.

11. The brake system of claim 10, wherein each of the first and second bypass iso valves includes a check valve mechanism selectively permitting fluid flow therethrough.

12. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves is a same iso valve type as is the iso valve of the iso/dump control valve arrangement.

13. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves is oriented in an opposite fluid flow direction as is the iso valve of the iso/dump control valve arrangement.

14. The brake system of claim 1, wherein the low pressure accumulator is a first low pressure accumulator, and wherein the brake system includes a second low pressure accumulator spaced hydraulically apart from the first low pressure accumulator by the secondary brake module, each of the first and second low pressure accumulators being operative to selectively regulate hydraulic fluid for a corresponding first or second pair of wheel brakes.

15. The brake system of claim 1, wherein the first and second bypass iso valves each include:
an MC passage in fluid communication with a corresponding first or second MC outlet;
a brake-side passage in fluid communication with a corresponding front wheel brake;
a longitudinally extending bypass valve sleeve;
a bypass valve body having longitudinally spaced first and second body ends with a bypass body lumen extending therebetween, the bypass valve body spacing at least a portion of the bypass valve sleeve, at least partially surrounding the first body end, away from at least the brake-side passage, located adjacent the second body end;
a bypass armature located within the bypass valve sleeve adjacent the first body end;
a bypass tappet at least partially surrounded by the bypass armature and the bypass valve sleeve, the bypass tappet extending at least partially through the bypass body lumen, the bypass tappet being selectively moved longitudinally within the bypass body lumen toward the bypass valve body via energization of the bypass armature; and
a bypass valve seat carried by a bypass seat body located directly adjacent the second body end;
wherein a bypass valve fluid path extends through a selected one of the MC passage and the brake-side passage, through the bypass valve seat, through at least one laterally extending side aperture in the bypass valve body through at least a portion of the bypass body lumen, and through the other one fo the MC passage and the brake-side passage; and
wherein the bypass tappet selectively engages with the bypass valve seat to substantially occlude the bypass valve fluid path responsive to energization of the bypass armature moving the bypass tappet toward the second body end.

16. The brake system of claim 1, wherein the low pressure accumulator includes:
an LPA cavity including at least one brake-side passage adjacent a first end thereof;
an LPA piston for reciprocal longitudinal motion within the LPA cavity responsive to a predetermined amount of hydraulic fluid flow through the brake-side passage;
an LPA biasing spring for urging the LPA piston toward the first end of the LPA cavity; and
an LPA limiter, including an LPA rod and an LPA cage, for selectively limiting longitudinal travel of at least one of the LPA biasing spring and the LPA piston;
wherein the LPA rod is connected to a selected one of the LPA piston and a second end of the LPA cavity, longitudinally spaced from the first end, and the LPA cage is permitted to move longitudinally with respect to the selected one.

17. The brake system of claim 16, wherein the LPA piston includes a circumferential LPA seal groove about a head portion thereof and a directional LPA seal carried within the LPA seal groove longitudinally reciprocally with respect to an inner wall of the LPA cavity for preventing fluid flow longitudinally therepast.

18. The brake system of claim 16, wherein the LPA cavity includes a circumferential LPA seal groove in an inner wall of the LPA cavity and spaced longitudinally between first and second ends thereof, a directional LPA seal being located within the LPA seal groove and for preventing fluid flow longitudinally therepast during reciprocal motion of the LPA piston within the LPA cavity.

19. The brake system of claim 16, wherein at least a portion of the LPA cage is interposed laterally between the LPA piston and the inner wall of the LPA cavity, for sliding motion with respect to both.

20. The brake system of claim 19, wherein the LPA piston includes a circumferential LPA seal groove about a head portion thereof and a nondirectional second LPA seal within the LPA seal groove, the LPA seal groove sliding longitudinally reciprocally with respect to an inner wall of the LPA cage for preventing fluid flow longitudinally therepast.
